(19) United States
(12) Patent Application Publication
(10) Pub. No.: US 2016/0231487 A1
(43) Pub. Date: Aug. 11, 2016

(54) High Contrast Inverse Polarizer

(71) Applicant: Moxtek, Inc., Orem, UT (US)

(72) Inventors: Ted Wangensteen, Pleasant Grove, UT (US); Bin Wang, Lindon, UT (US); Matt George, Murray, UT (US); Paul Steven Mills, Orem, UT (US); Arash Farhang, Salt Lake City, UT (US)

(21) Appl. No.: 15/006,566

(22) Filed: Jan. 26, 2016

Related U.S. Application Data
(60) Provisional application No. 62/113,101, filed on Feb. 6, 2015.

(51) Int. Cl. G02B 5/30; G02B 27/00

(52) U.S. Cl. CPC G02B 5/3058; G02B 27/0012

(57) ABSTRACT

An embedded, inverse wire-grid polarizer (WGP) includes ribs 13 located over a surface of a transparent substrate 11, gaps 16 between the ribs 13, and a fill-layer 15 substantially filling the gaps 16. The fill-layer has a relatively high index of refraction, such as greater than 1.4. At a wavelength of light incident upon the WGP, E_{∥} transmission can be greater than E_{⊥} transmission. E_{∥} is a polarization of light with an electric field oscillation parallel to a length L of the ribs, and E_{⊥} is a polarization of light with an electric field oscillation perpendicular to a length L of the ribs. This embedded, inverse WGP is especially useful for polarizing, with high WGP performance, small wavelength (high-energy) regions of the electromagnetic spectrum (e.g. UV) which are difficult to polarize with conventional WGPs (E_{⊥} transmission>E_{∥} transmission).

### CLAIM OF PRIORITY

This claims priority to US Provisional Patent Application No. 62/113,101, filed on Feb. 6, 2015, which is hereby incorporated herein by reference in its entirety.

### FIELD OF THE INVENTION

The present application is related generally to wire-grid polarizers.

### BACKGROUND

Wire-grid polarizers (WGPs or WGP for singular) can be used to divide light into two different polarization states. One polarization state can mostly pass through the WGP and the other can be mostly absorbed or reflected. The effectiveness or performance of WGPs is based on a high percent transmission of one polarization and minimal transmission of an opposite polarization. A percent transmission of the primarily-transmitted polarization divided by a percent transmission of the opposite polarization is called contrast. It can be difficult to manufacture WGPs that provide sufficiently-high contrast. High contrast can sometimes be obtained by reducing the pitch of the wires/ribs, but doing so can be a difficult manufacturing challenge, especially for smaller wavelengths. It would be beneficial to find a way to improve WGP performance by some way other than a reduction in pitch.

### SUMMARY

It has been recognized that it would be advantageous to improve wire-grid polarizer (WGP or WGPs for plural) performance by some way other than a reduction in pitch. The present invention is directed to various embodiments of embedded, inverse WGPs, methods of polarizing light, and methods of designing embedded, inverse WGPs, that satisfy these needs. Each embodiment may satisfy one, some, or all of these needs. For the following WGPs and methods, E_{∥} is a polarization of light with an electric field oscillation parallel to a length L of the ribs and E₁₉₅ is a polarization of light with an electric field oscillation perpendicular to a length L of the ribs.

The embedded, inverse WGP can comprise ribs located over a surface of a transparent substrate, gaps between the ribs, and a fill-layer substantially filling the gaps. The ribs can be elongated and can be formed into an array. At a wavelength of light incident upon the WGP, E_{∥} transmission can be greater than E₁₉₅ transmission. The fill-layer can have an index of refraction greater than 1.4 at the wavelength of the light.

The method of polarizing light can comprise providing an inverse, embedded WGP and transmitting more E_{∥} through the WGP than E_{⊥}. The method of designing an embedded, inverse WGP can comprise calculating a pitch of an array of ribs of the WGP for E_{∥} transmission>E₁₉₅ transmission at a desired wavelength and calculating an index of refraction of a fill-layer, located over the array of ribs and substantially filling gaps between the ribs, for E_{∥} transmission>E_{⊥} transmission at the desired wavelength.

### BRIEF DESCRIPTION OF THE DRAWINGS (DRAWINGS MIGHT NOT BE DRAWN TO SCALE)

FIG. 1a is a schematic cross-sectional side view of an embedded, inverse wire-grid polarizer (WGP) 10 comprising ribs 13 located over a surface of a transparent substrate 11, gaps 16 between the ribs 13, and a fill-layer 15 substantially filling the gaps 16, in accordance with an embodiment of the present invention.

FIG. 1b is a schematic perspective-view of an embedded, inverse wire-grid polarizer (WGP) 10 comprising ribs 13 located over a surface of a transparent substrate 11, gaps 16 between the ribs 13, and a fill-layer 15 substantially filling the gaps 16, in accordance with an embodiment of the present invention.

FIG. 2 is a schematic cross-sectional side view of WGP 20, similar to WGP 10, except that the fill-layer 15 of WGP 20 extends from the gaps 16 over the ribs 13, in accordance with an embodiment of the present invention.

FIG. 3 is a schematic cross-sectional side view of WGP 30, similar to WGPs 10 & 20, except that the ribs 13 of WGP 30 include a substantial difference between a lower-rib-width W_{L} and an upper-rib-width W_{H}, in accordance with an embodiment of the present invention.

FIG. 4 is a schematic perspective view of an integrated circuit (IC) inspection tool 40, using at least one WGP 44 to polarize light 45, in accordance with an embodiment of the present invention.

FIG. 5 is a schematic perspective view of a flat panel display (FPD) manufacturing tool 50, using at least one WGP 54 to polarize light 55, in accordance with an embodiment of the present invention.

### DEFINITIONS

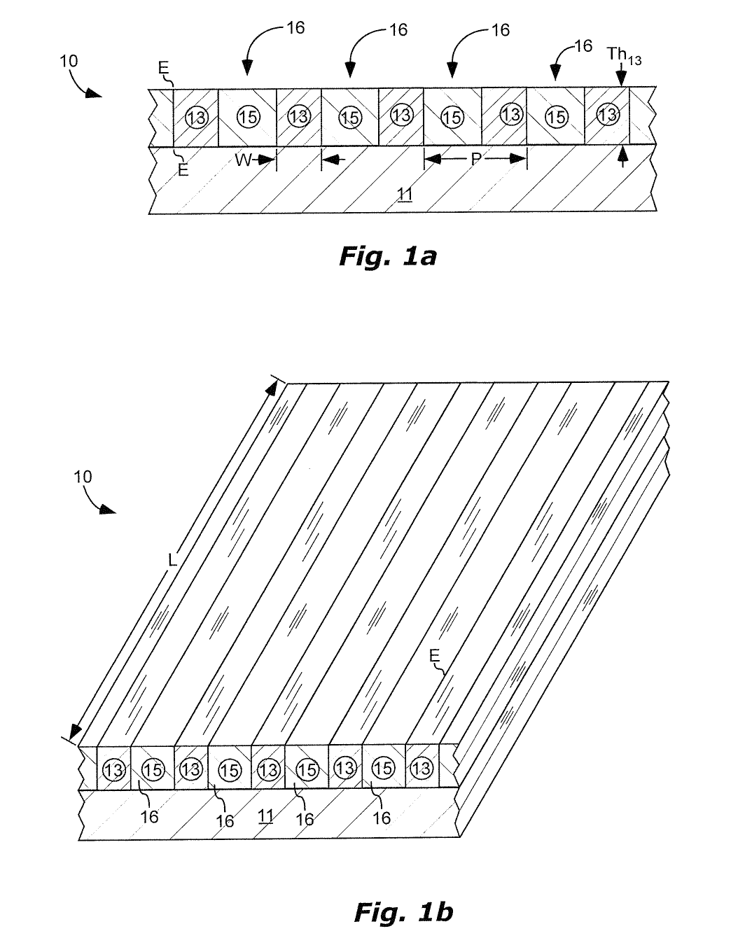

As used herein, the term “elongated” means that a length L (see FIG. 1b) of the ribs 13 is substantially greater than rib width W or rib thickness Th₁₃ (see FIGS. 1a, 2, and 3). For example, WGPs for ultraviolet or visible light can have a rib width W between 20 and 100 nanometers and rib thickness between 50 and 500 nanometers; and rib length of about 1 millimeter to 20 centimeters or more, depending on the application. Thus, elongated ribs 13 can have a length L that is many times (e.g. at least 10 times in one aspect, at least 100 times in another aspect, at least 1000 times in another aspect, or at least 10,000 times in another aspect) larger than rib width W or rib thickness Th₁₃.

As used herein, the term “light” can mean light or electromagnetic radiation in the x-ray, ultraviolet, visible, and/or infrared, or other regions of the electromagnetic spectrum.

As used herein, the term “thin-film layer” means a continuous layer that is not divided into a grid.

As used herein, the term “width” of the rib means the maximum width of the rib, unless specified otherwise.

Many materials used in optical structures absorb some light, reflect some light, and transmit some light. The following definitions are intended to distinguish between materials or structures that are primarily absorptive, primarily reflective, or primarily transparent. Each material can be primarily absorptive, primarily reflective, or primarily transparent in a specific wavelength of interest (e.g. all or a portion of the ultraviolet, visible, or infrared spectrums of light) and can have a different property in a different wavelength of interest.

1. As used herein, the term “absorptive” means substantially absorptive of light in the wavelength of interest.
a. Whether a material is “absorptive” is relative to other materials used in the polarizer. Thus, an absorptive structure will absorb substantially more than a reflective or a transparent structure.
b. Whether a material is “absorptive” is dependent on the wavelength of interest. A material can be absorptive in one wavelength range but not in another.
c. In one aspect, an absorptive structure can absorb greater than 40% and reflect less than 60% of light in the wavelength of interest (assuming the absorptive structure is an optically thick film—i.e. greater than the skin depth thickness).
d. In another aspect, an absorptive material can have a high extinction coefficient (k), relative to a transparent material, such as for example greater than 0.01 in one aspect or greater than 1.0 in another aspect.
e. Absorptive ribs can be used for selectively absorbing one polarization of light.
2. As used herein, the term “reflective” means substantially reflective of light in the wavelength of interest.
   a. Whether a material is “reflective” is relative to other materials used in the polarizer. Thus, a reflective structure will reflect substantially more than an absorptive or a transparent structure.
   b. Whether a material is “reflective” is dependent on the wavelength of interest. A material can be reflective in one wavelength range but not in another. Some wavelength ranges can effectively utilize highly reflective materials. At other wavelength ranges, especially lower wavelengths where material degradation is more likely to occur, the choice of materials may be more limited and an optical designer may need to accept materials with a lower reflectance than desired.
   c. In one aspect, a reflective structure can reflect greater than 80% and absorb less than 20% of light in the wavelength of interest (assuming the reflective structure is an optically thick film—i.e. greater than the skin depth thickness).
   d. Metals are often used as reflective materials.
   e. Reflective wires can be used for separating one polarization of light from an opposite polarization of light.
3. As used herein, the term “transparent” means substantially transparent to light in the wavelength of interest.
   a. Whether a material is “transparent” is relative to other materials used in the polarizer. Thus, a transparent structure will transmit substantially more than an absorptive or a reflective structure.
   b. Whether a material is “transparent” is dependent on the wavelength of interest. A material can be transparent in one wavelength range but not in another.
   c. In one aspect, a transparent structure can transmit greater than 90% and absorb less than 10% of light at the wavelength of interest or wavelength range of use, ignoring Fresnel reflection losses.
   d. In another aspect, a transparent structure can have an extinction coefficient (k) of less than 0.01, less than 0.001, or less than 0.0001 in another aspect, at the wavelength of interest or wavelength range of use.
4. As used in these definitions, the term “material” refers to the overall material of a particular structure. Thus, a structure that is “absorptive” is made of a material that as a whole is substantially absorptive, even though the material may include some reflective or transparent components. Thus for example, a rib made of a sufficient amount of absorptive material so that it substantially absorbs light is an absorptive rib even though the rib may include some reflective or transparent material embedded therein.

### DETAILED DESCRIPTION

As illustrated in FIGS. 1a, 1b, 2, and 3, embedded, inverse wire-grid polarizers (WGPs or WGP for singular) 10, 20, and 30 are shown comprising ribs 13 located over a surface of a transparent substrate 11. The ribs 13 can be elongated and can be formed into an array. The ribs 13 can be reflective, or can include a reflective portion. The ribs 13 can include an absorptive portion. The ribs 13 can be a metal or a dielectric or can include different regions, at least one of which is a metal and at least one of which is a dielectric.

For the following discussion, E_{∥} is a polarization of light with an electric field oscillation parallel to a length L of the ribs and E₁₉₅ is a polarization of light with an electric field oscillation perpendicular to a length L of the ribs. In typical WGP use, E₁₉₅ is primarily transmitted and E_{∥} is primarily reflected or absorbed. A WGP can be used as an inverse WGP in a wavelength range of light where E_{∥} is primarily transmitted and E_{⊥} is primarily reflected or absorbed (E_{∥} transmission>E₁₉₅ transmission). Merely having E_{∥} transmission>E_{⊥} transmission is insufficient for many applications, and it can be important to optimize performance of the inverse WGP, meaning a high E_{∥} transmission and/or high contrast (E_{∥} transmission/E₁₉₅ transmission). The WGP structure can be optimized for improved inverse WGP performance.

The WGPs 10, 20, and 30 can have gaps 16 between the ribs 13. The term “gap” means a space, opening, or divide, separating one rib from another rib. A fill-layer 15, substantially filling the gaps 16, and especially a fill-layer 15 with a relatively large index of refraction, can improve inverse WGP performance. For example, an index of refraction of the fill-layer 15 can be greater than 1.4 in one aspect, greater than 1.5 in another aspect, greater than 1.6 in another aspect, or greater than 1.8 in another aspect. The aforementioned index of refraction values are those at the light wavelength of intended use, where E_{∥} transmission>E₁₉₅ transmission. The fill-layer 15 can be a solid material or liquid. The fill-layer 15 can be transparent. Examples of fill-layer materials, for polarization of ultraviolet light, include Al₂O₃ (n=1.8 at λ=300 nm), ZrO₂ (n=2.25 at λ=361 nm), and HfO₂ (n=2.18 at λ=365 nm).

Use of a fill-layer 15 to improve WGP performance, and especially use of a fill-layer with a relatively large index of refraction, is contrary to conventional WGP design theory. For example, see U.S. Pat. No. 6,288,840, column 6, line 59 through column 7, line 15. A conventional WGP (E1 transmission>E_{∥} transmission) may include a fill-layer for protection of the ribs, accepting a reduction in WGP performance. For example, see U.S. Pat. No. 6,288,840, column 1, lines 18-54.

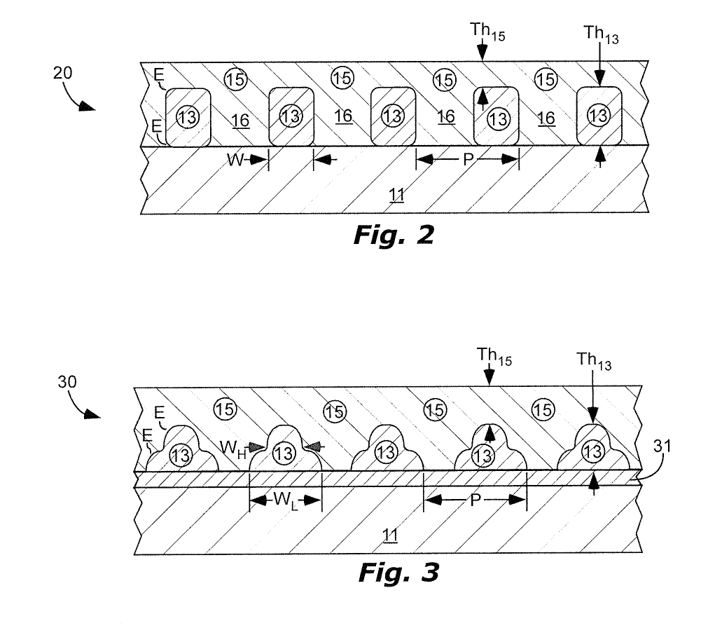

The fill-layer 15 of WGPs 20 and 30 in FIGS. 2-3 substantially fills the gaps 16 and extends from the gaps 16 over the ribs 13 such that the fill-layer 15 in each gap 16 extends continuously over adjacent ribs 13 to the fill-layer 15 in each adjacent gap 16. Extending the fill-layer 15 over the ribs 13, and using certain thicknesses Th₁₅ of the fill-layer 15 over the ribs 13, can improve inverse WGP performance. The fill-layer 15 can extend over the ribs for a thickness Th₁₅ optimized for the desired wavelength range of use. For example, the fill-layer 15 can extend over the ribs for a thickness Th₁₅ of at least 25 nanometers in one aspect, at least 50 nanometers in another aspect, or at least 60 nanometers in another aspect, and less than 90 nanometers in one aspect, less than 100 nanometers in another aspect, or less than 150 nanometers in another aspect.

Use of a substrate 11 and/or a thin-film layer 31 (see FIG. 3) between the ribs 13 and the substrate 11, with a relatively large index of refraction, can improve inverse WGP performance and can shift the wavelength range at which E_{∥} transmission>E_{⊥} transmission. For example, an index of refraction of the substrate 11 and/or the thin-film layer 31 can be greater than 1.4 in one aspect, greater than 1.5 in another aspect, greater than 1.6 in another aspect, or greater than 1.8 in another aspect. The aforementioned index of refraction values are those at the light wavelength of intended use, where E_{∥} transmission>E₁₉₅ transmission.

Rib 13 pitch P can be selected to improve inverse WGP performance and to shift the wavelength range at which E_{∥} transmission>E₁₉₅ transmission. In conventional WGPs, the pitch needed for high-performance polarization can be less than one-half of the smallest wavelength in the desired polarization wavelength range. Consequently, a pitch of less than 150 nanometers is typically used for polarization of visible light (λ/P≈150/400=2.67), and around 100 nanometers or less for polarization of ultraviolet light. Manufacture of such polarizers can be difficult and costly due to this small pitch. Fortunately, optimal pitch P, for inverse WGPs described herein, can be larger than a pitch needed for conventional polarizers, thus improving the manufacturability of these inverse WGPs.

For example, the wavelength of the light of desired inverse polarization divided by a pitch P of the ribs 13 can be less than 2.5 in one aspect, less than 2.0 in another aspect, less than 1.9 in another aspect, less than 1.8 in another aspect, or less than 1.7 in another aspect. As another example, for inverse polarization of light with a wavelength of less than 400 nanometers (e.g. ultraviolet light), a pitch P of the ribs 13 can be greater than 140 nanometers. Pitch P of the ribs 13 and an index of refraction n of the fill-material 15 can be selected by the following equation: P*(n−0.2)<λ<P*(n+0.2), where λ is the wavelength of the light of desired inverse polarization.

Although pitch P for inverse polarization may be relatively large, for polarization of small wavelengths of light, such as less than 260 nanometer light in one aspect or less than 200 nanometer light in another aspect, small pitches P may be needed, such as for example less than 100 nanometers in one aspect, less than 80 nanometers in another aspect, or even less than 60 nanometers in another aspect.

A duty-cycle (W/P) of the ribs 13 can be selected to improve inverse WGP performance and to shift the wavelength range at which E_{∥} transmission>E₁₉₅ transmission. For example, the following duty-cycles can improve contrast: greater than 0.45 in one aspect or greater than 0.55 in another aspect, and less than 0.60 in one aspect, less than 0.65 in another aspect, less than 0.70 in another aspect, or less than 0.80 in another aspect.

A lower duty-cycle can be selected to improve transmission of E_{∥}, and can broaden the wavelength range of high E_{∥} transmission, but possibly by sacrificing contrast. Thus, a duty-cycle can be selected for improved transmission of E_{∥}, such as for example less than 0.7 in one aspect, less than 0.6 in another aspect, less than 0.5 in another aspect, or less than 0.4 in another aspect. For example, for a wavelength range of light of at least 30 nanometers, E_{∥} transmission>E₁₉₅ transmission and E_{∥} transmission can be greater than 80%. This wavelength range of light can be in a region of the electromagnetic spectrum of less than 400 nanometers, e.g. ultraviolet spectrum.

A smaller rib thickness Th₁₃ can improve contrast. For example, rib thickness Th₃ can be less than 70 nanometers in one aspect, less than 55 nanometers in another aspect, or less than 45 nanometers in another aspect.

Rib 13 shape can be selected to improve inverse WGP performance and to shift the wavelength range at which E_{∥} transmission>E_{⊥} transmission. Edges E (i.e. corners) of the ribs 13 can be approximately 90 degrees, thus forming rectangular-shaped ribs 13, as shown in FIGS. 1a and 1b. Alternatively, the edges E of the ribs 13 can be rounded, and thus a cross-sectional-profile of the ribs 13 can include a rounded shape, as shown in FIGS. 2-3. One, two, three, or more than three of the edges E of each rib 13 can be rounded. An end of the ribs 13 farther from the substrate (i.e. top of the ribs 13) can have a rounded-shape and/or an end of the ribs 13 closest to the substrate (i.e. bottom of the ribs 13) can be rounded. The ribs 13 can be formed with different shapes by adjusting the anisotropic/isotropic character of the etch, and other etch parameters, throughout the etch process.

Ribs 13 with multiple widths W_{L} and W_{H} in each rib 13, as shown on WGP 30 in FIG. 3, can broaden the wavelength range of high contrast. For example, a difference between a lower-rib-width W_{L} and an upper-rib-width W_{H} can be greater than 10 nanometers in one aspect, greater than 20 nanometers in another aspect, or greater than 30 nanometers in another aspect. Lower-rib-width W_{L} means a maximum width of the ribs 13 in a lower-half of the rib 13 closer to the substrate 11. Upper-rib-width W_{H} means a maximum width of the ribs 13 in an upper-half of the rib 13 farther from the substrate. The inventors found that, by selecting a difference between a lower-rib-width W_{L} and an upper-rib-width W_{H} of greater than 20 nanometers, for a wavelength range of light of at least 20 nanometers in the ultraviolet spectrum, the E_{∥} transmission divided by the E₁₉₅ transmission can be at least 300. The ribs 13 can be formed with a different lower-rib-width W_{L} and an upper-rib-width W_{H} by adjusting the anisotropic/isotropic character of the etch, and other etch parameters, throughout the etch process.

WGPs described herein can be made with E_{∥} transmission>E₁₉₅ transmission, with high contrast (E_{∥} transmission/E_{⊥} transmission), and with high E_{∥} transmission, even in the difficult to polarize regions of the electromagnetic spectrum. For example, the WGPs described herein can have E_{∥} transmission>E_{⊥} transmission and contrast of at least 10 in one aspect, at least 100 in another aspect, at least 300 in another aspect, at least 400 in another aspect, at least 1000 in another aspect, at least 5000 in another aspect, or at least 10,000 in another aspect, at a certain wavelength or wavelength range. As another example, the WGPs described herein can have E_{∥} transmission of at least 70 &, at least 80%, or at least 90%, at a certain wavelength or wavelength range. These WGP performance numbers can even be achieved at a wavelength or a wavelength range of light in the electromagnetic spectrum of less than 400 nanometers in one aspect, less than 300 nanometers in another aspect, less than 270 nanometers in another aspect, or a wavelength in or across the ultraviolet spectrum in another aspect.

A method of polarizing light can comprise one or more of the following:
1. providing an inverse, embedded WGP as described herein; and
2. transmitting more E_{∥} through the WGP than E_{⊥} with contrast (E_{∥} transmission/E_{⊥} transmission) as described above and at a wavelength or wavelength range as described herein.

A method of designing an embedded, inverse WGP can comprise one or more of the following for matching or tuning the inverse WGP performance (E_{∥} transmission>E₁₉₅ transmission) to a desired wavelength or wavelength range and/or for improving WGP performance (contrast and/or %E_{∥} transmission) at that wavelength or wavelength range:
1. calculating a pitch of an array of ribs 13;
2. calculating an index of refraction of a fill-layer 15, located over the array of ribs 13 and substantially filling gaps 16 between the ribs 13;
3. selecting rib 13 material;
4. selecting rib thickness Th₁₃;
5. selecting duty cycle (W/P);
6. selecting rib 13 shape;
7. selecting thickness Th₁₅ of the fill-layer 15 over the array of ribs 13; and
8. selecting substrate material.

Integrated circuits (ICs or IC) can be made of semiconductor material and can include nanometer-sized features. ICs can be used in various electronic devices (e.g. computer, motion sensor, etc.). Defects in the IC can cause the electronic device to fail. Thus, inspection of the IC can be important for avoiding failure of the electronic device, while in use by the consumer. Such inspection can be difficult due to the small feature-size of IC components. Light, with small wavelengths (e.g. ultraviolet), can be used to inspect small feature-size components. It can be difficult to have sufficient contrast between these small feature-size components and defects or their surroundings. Use of polarized light can improve integrated circuit (IC) inspection contrast. It can be difficult to polarize the small wavelengths of light (e.g. ultraviolet/UV) used for IC inspection. Polarizers that can polarize such small wavelengths, and that can withstand exposure to high-energy wavelengths of light, may be needed.

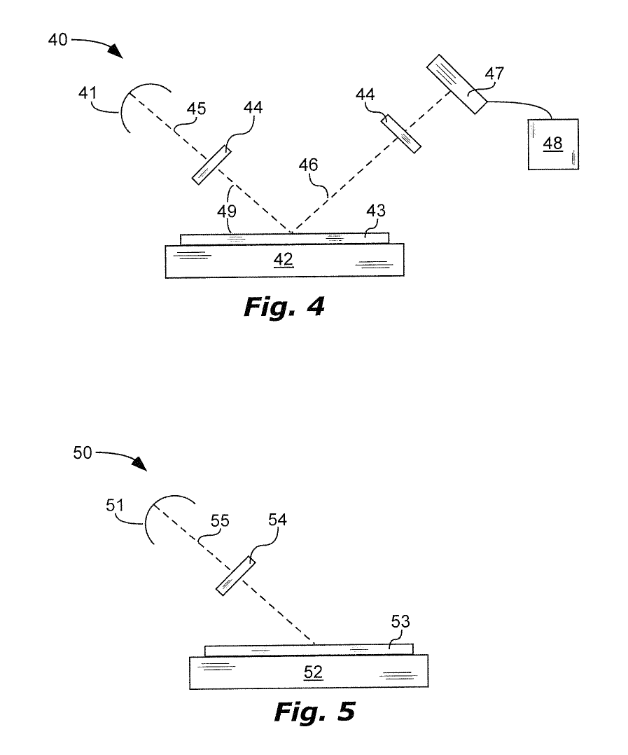

The WGPs described herein can polarize small wavelengths of light (e.g. UV) and can be made of materials sufficiently durable to withstand exposure to such light. The fill-material 15 can protect the ribs 13 from UV light damage. An IC inspection tool 40 is shown in FIG. 4, comprising a light source 41 and a stage 42 for holding an IC wafer 43. The light source 41 can be located to emit an incident light-beam 45 (e.g. visible, ultraviolet, or x-ray) onto the IC wafer 43. The incident light-beam 45 can be directed to the wafer 43 by optics (e.g. mirrors). The incident light-beam 45 can have an acute angle of incidence 49 with a face of the wafer 43. To improve inspection contrast, a WGP 44 (according to an embodiment described herein) can be located in, and can polarize, the incident light-beam 45.

A detector 47 (e.g. CCD) can be located to receive an output light-beam 46 from the IC wafer 43. An electronic circuit 48 can be configured to receive and analyze a signal from the detector 47 (the signal based on the output light-beam 46 received by the detector 47). To improve inspection contrast, a WGP 44 (according to an embodiment described herein) can be located in, and can polarize, the output light-beam 46.

The WGPs described herein can be used in the manufacture of flat panel displays (FPDs for plural or FPD for singular). FPDs can include an aligned polymer film and liquid crystal. An FPD manufacturing tool 50 is shown in FIG. 5, comprising a light source 51, a stage 52 for holding an FPD 53, and a WGP 54 (according to an embodiment described herein). The light source 51 can emit ultraviolet light 55. The WGP 54 can be located between the light source 51 and the stage 52 and can polarize the ultraviolet light 55. Exposing the FPD 53 to polarized ultraviolet light 55 can align the polymer film. See U.S. Pat. No. 8,797,643 and 8,654,289, both incorporated herein by reference. Exposing the FPD 53 to polarized ultraviolet light 55 can help repair the FPD 53. See U.S. Pat. No. 7,697,108, which is incorporated herein by reference.

What is claimed is:

1. An embedded, inverse wire-grid polarizer (WGP) comprising ribs located over a surface of a transparent substrate, gaps between the ribs, and a fill-layer substantially filling the gaps, wherein:
a. the ribs are elongated and formed into an array;
b. at a wavelength of light incident upon the WGP, E₁₉₅ transmission>E_{⊥} transmission, where:
i. E_{∥} is a polarization of the light with an electric field oscillation parallel to a length of the ribs; and
ii. E_{⊥} is a polarization of the light with an electric field oscillation perpendicular to a length of the ribs; and
c. the fill-layer has an index of refraction greater than 1.4 at the wavelength of the light.

2. The embedded, inverse WGP of claim 1, wherein P*(n-0.2)<λ<P*(n+0.2), where:
a. λ is the wavelength of the light;
b. P is a pitch of the ribs; and
c. n is the index of refraction of the fill-layer.

3. The embedded, inverse WGP of claim 1, wherein the fill-layer substantially fills the gaps and extends from the gaps over the ribs such that the fill-layer in each gap extends continuously over adjacent ribs to the fill-layer in each adjacent gap.

4. The embedded, inverse WGP of claim 3, wherein the fill-layer extends over the ribs for a thickness of between 50 and 100 nanometers.

5. The embedded, inverse WGP of claim 1, wherein, at the wavelength of the light, the E_{∥} transmission divided by the E₁₉₅ transmission is at least 1000.

6. The embedded, inverse WGP of claim 1, wherein:
a. the wavelength of the light is less than 400 nanometers; and
b. the E_{∥} transmission divided by the E_{⊥} transmission is at least 300.

7. The embedded, inverse WGP of claim 6, wherein:
a. the wavelength of the light is less than 400 nanometers; and
b. a pitch of the ribs is greater than 140 nanometers.

8. The embedded, inverse WGP of claim 6, wherein a width of the ribs divided by a pitch of the ribs is between 0.45 and 0.65.

9. The embedded, inverse WGP of claim 1, wherein:
a. a width of the ribs divided by a pitch of the ribs is less than 0.7;
b. the wavelength of the light is less than 400 nanometers;
c. for a wavelength range of light of at least 30 nanometers, that includes the wavelength of the light, E_{∥} transmission is greater than 80%; and
d. the E_{∥} transmission divided by the E₁₉₅ transmission is at least 10.

10. The embedded, inverse WGP of claim 1, wherein the wavelength of the light divided by a pitch of the ribs is less than 2.

11. The embedded, inverse WGP of claim 1, wherein the index of refraction of the fill-layer is greater than 1.5.

12. The embedded, inverse WGP of claim 1, wherein the fill-layer is transparent.

13. The embedded, inverse WGP of claim 1, wherein:
a. a difference between a lower-rib-width and an upper-rib-width is greater than 20 nanometers, where:
i. lower-rib-width means a maximum width of the ribs in a lower-half of the rib closer to the substrate; and
ii. upper-rib-width means a maximum width of the ribs in an upper-half of the rib farther from the substrate; and
b. for a wavelength range of light of at least 20 nanometers in the ultraviolet spectrum, the E_{∥} transmission divided by the E_{⊥} transmission is at least 300.

14. The embedded, inverse WGP of claim 1, wherein:
a. a cross-sectional-profile of the ribs includes a rounded shape; and
b. for a wavelength of light in the ultraviolet spectrum, the E_{∥} transmission divided by the E_{⊥} transmission is at least 300.

15. The embedded, inverse WGP of claim 1, wherein the WGP forms part of an integrated circuit (IC) inspection tool, the IC inspection tool comprising:
a. an ultraviolet light source;
b. a stage for holding an IC wafer;
c. the ultraviolet light source located to emit an incident ultraviolet light-beam onto the IC wafer;
d. a detector located to receive an output light-beam from the IC wafer;
e. an electronic circuit configured to receive and analyze a signal from the detector, the signal based on the output light-beam received by the detector; and
f. the WGP located in a path of the incident light-beam, a path of the output light-beam, or both.

16. The embedded, inverse WGP of claim 1, wherein the WGP forms part of a flat panel display (FPD) manufacturing tool, the FPD manufacturing tool comprising:
a. a light source capable of emitting ultraviolet light;
b. a stage for holding an FPD; and
c. the WGP, located between the light source and the stage, and configured to polarize the ultraviolet light with E_{∥} transmission>E₁₉₅ transmission.

17. A method of polarizing light, the method comprising:
a. providing an inverse wire-grid polarizer (WGP) comprising an array of elongated ribs located over a surface of a transparent substrate, gaps between at least a portion of the ribs, and a fill-layer filling the gaps between the adjacent ribs; and
b. transmitting more E_{∥} through the WGP than E_{⊥}, where:
i. E_{∥} is a polarization of the light with an electric field oscillation parallel to a length of the ribs; and
ii. E₁₉₅ is a polarization of the light with an electric field oscillation perpendicular to a length of the ribs.

18. The method of claim 17, wherein, at a wavelength in the ultraviolet spectrum, the E_{∥} transmission divided by the E_{⊥} transmission is at least 300.

19. A method of designing an embedded, inverse wire-grid polarizer (WGP), the method comprising:
a. calculating a pitch of an array of ribs of the WGP for E_{∥} transmission>E₁₉₅ transmission at a desired wavelength, where:
i. E_{∥} is a polarization of the light with an electric field oscillation parallel to a length of the ribs; and
ii. E_{⊥} is a polarization of the light with an electric field oscillation perpendicular to a length of the ribs; and
b. calculating an index of refraction of a fill-layer, located over the array of ribs and substantially filling gaps between the ribs, for E_{∥} transmission>E_{⊥} transmission at the desired wavelength.

20. The method of claim 19, further comprising selecting at least two of the following to increase E_{∥} transmission divided by E_{⊥} transmission at the desired wavelength: rib material, rib thickness, rib shape, rib width divided by rib pitch, substrate material, and thickness of the fill-layer over the array of ribs.
